(19) United States
(12) Patent Application Publication
(10) Pub. No.: US 2004/0128282 A1
(43) Pub. Date: Jul. 1, 2004

(54) System and method for computer searching

(76) Inventors: Paul Kleinberger, Jerusalem (IL); Ron Jacobson, Tel Aviv (IL); Shlomo Bezem, Macabim (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/220,710

(22) PCT Filed: Mar. 7, 2001
(86) PCT No.: PCT/IL01/00214

(51) Int. Cl. G06F 17/30

(52) U.S. Cl. 707/3

(57) ABSTRACT

A method for computer searching, including receiving an initial data set from a data set source (1), prioritizing items according to user's preferences (2), deselecting data items having low priority (3) and displaying results (4).

### CROSS-REFERENCE TO RELATED APPLICATIONS

This application claims the benefit of U.S. Provisional Application No. 60/187,415 filed Mar. 7, 2000.

### FIELD AND BACKGROUND OF THE INVENTION

This invention relates to methods for computer searching. More particularly, it relates to methods for adapting computer searches to the needs of particular searchers, and for prioritizing the results of computer searches according to the needs of particular searchers. It further relates to methods for generating a display of search results, to facilitate a searcher's understanding of the nature and scope of the information found by his search. It further relates to creating a display of found information convenient for particular searchers, particularly for searchers searching in a foreign language. It further relates to methods for garnering information about users of a search system or other computer system.

Searching the Internet is a frequent activity for millions of Internet users. The major Internet search engines are among the most important and best funded Internet companies, and their sites are among the most popular on the net. Yet, the state of the art in computer searching leaves much to be desired. A typical Internet search finds massive amounts of irrelevant data. Users have no choice but to winnow through long lists of found sites, reading description after description, before finding the relatively few sites actually relevant to their needs. Systems for searching Intranets, Extranets, and Local Area Networks and even personal computers generally suffer from these same disadvantages.

Most search engines attempt to prioritize the results they present. A typical Internet search may report ten thousand, a hundred thousand, or even several million “hits”. Since most users are unlikely to actually look at more than the first 20, or 50, or 100 references, search engines try to put first in their lists of found sites those sites which are most likely to interest the user.

Various methods have been used to establish these priorities, including the number of links to a site (on the theory that the more other sites reference the site, the more important it is likely to be), and the number of user ‘hits’ a site receives (on the theory that the more popular a site is in general, the more likely it is to be relevant to any particular user).

Another known method is to prioritize search results according to the apparent importance of the searched word within the found document or site. On many engines searching the Internet, for example, if the searched word is mentioned in the URL of a found site (if for example one searched for “Ford” and found, among others, http://www.Ford.com), then the site is assumed to be highly relevant to the searcher. Similarly, if the word is mentioned numerous times on the site's html page, then it is presumed that that word is centrally important to the site's content (i.e. it was not mentioned accidentally or peripherally), and the site is accordingly given a high priority in the search results.

The above methods of prioritizing, and many similar methods, have in common that they categorize and prioritize the sites either according to characteristics of the site itself (a listing of its words, its meta-tags, its URL), or according to characteristics of the site in relation to other sites (how many other sites mention it or link to it) or in relation to the user population of the net as a whole (how many overall user hits it reports, or is observed to have).

To our knowledge, no search engines prioritize according to the needs or characteristics of the particular user making the search. Systems do exist which recommend particular objects to users. MovieLens is an example of such a system. These systems calculate similarity between the expressed opinions of a user and the expressed opinions of other users, and “recommend” to the particular user objects that were favorably viewed by viewers who expressed opinions similar to his. We do not know of any system, however, which prioritizes the results of keyword-based or text-based general-purpose searches based on this kind of information.

Computer search results are typically displayed in the form of a list of found items such as URLs, with or without a few lines of additional information further describing each item. Lists, however, even prioritized lists, are not usually an optimal method for presenting search results, as they require the user to inspect each item on the list individually, if he wishes to be sure not to miss relevant found information. One method by which this problem has been addressed in the past is demonstrated by search engines such as Yahoo and ODB, which present searchable information to a user in an organized hierarchical manner, or display categories of found information rather than lists of the found objects. Yet such systems have the disadvantage that they are simply displaying the relevant parts of a pre-organized hierarchy. The hierarchies themselves are painstakingly organized ‘by hand’ by teams of editors and information experts, and do not vary from one user to another nor from one search to another. Simply, the items found in response to a particular search are displayed in their fixed hierarchical context.

Hierarchies so constructed are indeed useful, but they have two major disadvantages:

One disadvantage is that since they are constructed by hand, by human editors, they are difficult to maintain and update, extremely work-intensive, and consequently are typically not well updated with respect to changes in the domain being searched (such as the Internet). It is reported that the sites using this method have not in fact indexed more than ten or fifteen percent of the web.

A second disadvantage is that such a hierarchy is fixed. The organization of major categories, minor categories, further sub-categories of the minor categories, etc. is determined in advance by the editorial staff, and is the same for all users and for all queries. Thus while their hierarchical organization of information is likely to be of some use to the “average” user with a general query, it nevertheless may be of limited usefulness to a particular user with a particular or detailed query, and it does not adapt itself to his particular needs.

Certain other search engines (Alta Vista, Northern Lights) present, as part of their display of search results, a listing of subject areas that fall within the area of the search. The user is then able to modify his search request by clicking on the sub-categories presented. However, these displays do not present an actual hierarchy to the user. Categories and sub-categories are not immediately visible in a manner that allows the user to appreciate the nature of the hierarchy as a whole. Neither do such displays provide the user with tools to manipulate the hierarchical display in a manner which facilitates the process by which they ignore irrelevant categories and focus in on categories of interest to them, such as would be the case if the user were able to explore the hierarchy by opening and closing categories as branches of a tree. Further, the methods of these search engines as well are based on the prior organization, by human editors, of the universe of information content as a whole, and the results do not reflect the organizational structure of the information found by any particular search.

U.S. Pat. Nos. 4,972,349 and 5,062,074 to Kleinberger do teach the display of a hierarchical organization of found documents as the result of a search. However, the searches contemplated therein are searches for documents in a collection of documents held by a single computer system, with no provision for Internet searching, nor for interfacing with standard search engines, nor for “meta-searching”, this being the process of sending a search request to several existing search engines, receiving their results lists, possibly further analyzing or organizing their results, and presenting the analyzed results to the user. Further, whereas Kleinberger did contemplate receiving input from the user as part of the process by which the hierarchical display is organized, he did not contemplate the storing of information from or about the user over the course of a number of searches or other interactions with the system, nor the use of such general information from or about the user or the user population in influencing the method of searching, the sources of information, the choice of results presented, nor the method of organization or presenting those results.

Another limitation of prior art is the fact that although the Internet today is searched by users from all over the world, little help is given to users speaking one language who wish to search material in other languages. One way this problem has been handled under prior art is to cause the search engine to limit the found material to a particular language. This is clearly not an optimal solution, however, as it prevents users from contact with material that might be useful to them. The prior art does not enable users to conduct their search in their own language, yet find sites whose pages are in other languages. Millions of users around the world read English with a certain amount of difficulty. These users might desire to visit and use Internet sites in English, but would prefer to conduct the search operation itself in their native language. Similarly, English speakers might wish to search for sites in a foreign language, yet prefer to conduct their search in English. Prior art does not, to our knowledge, provide such an option. Prior art in this domain does include systems which translate found HTML pages from one language to another, (Alta Vista does this, for example), yet those systems do not facilitate the user's interaction with the display of found information. They aid the user only after he has interacted with the search process, has read (without assistance) the display of found objects, and has selected a site to visit.

Another relevant area of prior art concerns methods for tailoring a search process to the needs of a specific user, or to the needs of a specific group of users, or to the needs of a specific type of user.

Prior art in this area seems to be limited to collecting and indexing of information on a particular subject or set of subjects. For example, several sites on the Internet offer searches on the subject of the game of golf. They index, and provide for searching, a variety of sites whose contents are of interest to users interested in playing golf or watching golf be played. However, there appear to be no search engines that tailor the search process itself, and the display of search results, to the tastes and abilities of a particular population of users. A young teenager searching for the word “glass” on the Internet will be interested in an entirely different set of URLs from those that would interest a physical chemist or an interior decorator, yet on existing search engines operating according to the principles known to prior art, the teenager, the physical chemist, and the decorator, searching on any given search engine, will receive identical sets of results despite their very different needs.

Another relevant area of prior art relates to methods for collecting information about users of a computer system, particularly of a search system. Information about users is useful, whether for tailoring the operation of a system or for other purposes. Information about users, their areas of interest, preferences, tastes, and behaviors, can be of great commercial value. Yet, information about users is not easily available. Users are often reluctant to provide such information to commercial Internet sites, and are resistant to allowing such information to be collected about them. Certain methods for collecting user information are of course in common use today on the Internet. The most popular of these is simply to request users to sign up with the site or service, and as part of the sign-up process to request from them certain demographic information. Zip code (indicating part of country, and in some cases type of neighborhood), age, type of occupation, and level of income are typical questions in this context. Other information can be gleaned from analysis of other details supplied by the user. His email address and/or IP address, for example, can often provide clues as to his location and (by implication) language preferences. This information is then typically used to control the selection of banner advertising to which the user is exposed. In the case of search engines, a combination of such demographic information on the one hand, and the user's current search request on the other, are often used in combination to select what is considered the most appropriate banner ad to present to him. A user searching for “notebook” is likely to find a banner ad from one of the notebook computer manufacturers accompanying his search results. If his IP address ends in “.fr”, he is also likely to see the banner ad in French.

These methods for collecting information about users, however, are limited in scope and provide only minimal information. Expanded methods for collecting such information would be useful both in the contexts of the various embodiments described herein, and in various other commercial and non-commercial contexts.

### SUMMARY OF THE INVENTION

This invention relates to methods for computer searching. More particularly, it relates to modifying procedures of computer searching and procedures for prioritizing the results of computer searches, using stored information known to the system about the searchers, so as to enhance the usefulness of the results to the searchers. It further relates to methods for automatically generating a hierarchical display of search results, and for adapting that display based on known information about the searcher. It further relates to translating search output for the convenience of searchers. It further relates to methods for garnering information about users based on their activities when using a computer search system or other computer system.

The present invention improves on prior art computer search and Internet search procedures, which improvements make it easier for a searcher to find what he needs. The embodiments described below constitute system and method for organizing the results of a search so that the searcher can easily ignore all the sites that are clearly irrelevant, and so that he can clearly see the found information in categories. Stored information about the user, both demographic information and information gleaned from his previous interactions with the search engine, is used to determine what kinds of information, and what methods of presenting information, are most likely to be of use to the searcher. Then, the search process and presentation of search results are tailored accordingly. A search process using these methods is more likely than a conventional search engine to provide the user with what he needs, and to provide it in a format that is easy for him to use.

The present invention overcomes the limitations of prior art by providing a method whereby items found by a search are presented to each particular user in a priority order which reflects that user's needs and tastes and characteristics. The use of such a system can greatly facilitate computer searching in many contexts. Consequently, one object of this invention is to use information known to the system about the searcher to influence the choice of sites presented in the reporting of the results of an Internet search, and similarly to use information known to the system about the searcher to influence the prioritization of the sites presented.

In computer searching according to the methods of prior art, searches are typically done anonymously, and any two users giving an identical query will receive identical results. The present invention overcomes this limitation of prior art by providing system and method whereby information about a particular user, known to the system, is used to influence methods of performing computer searches for that user, so as to fit the nature of the search and the display of the results more appropriately to the needs of each individual searcher.

The present invention further overcomes limitations of prior art by providing system and method for presenting items found by computer searching in an organized hierarchical display, the hierarchy being calculated based only on the found information and not based on a preexisting hierarchy of subjects known in advance to the system. Such a system can be useful in many contexts, and greatly facilitates searching of the Internet and other computerized contexts. Thus, it is a further object of the present invention to display the results of an Internet search in hierarchical format, where the hierarchy of texts is constructed “on the fly” as a result of a particular search executed by a particular user, and is not dependant on a hierarchical structure which was determined in advance of the particular search.

The present invention further overcomes limitations of prior art by providing system and method for interfacing with existing search engines, and overcoming the limitations of those engines by organizing the results they present, prioritizing according to known stored characteristics of a searcher, and also by presenting the items found by those search engines in a organized hierarchical display, although neither information about a prioritization for a particular user nor appropriate hierarchical information is provided by the output of the search engines themselves. This constitutes an important improvement over prior art because prioritization which takes into account the personal needs and characteristics of the individual user is more likely to be effective for that user than is prioritization based on characteristics of “average” users or of the general population. Moreover, a search system that presents search results in an organized hierarchical manner facilitates the user's understanding of what has been found. Moreover, such a system makes it easy for him to ignore, as a group, references to a multiplicity of sites that, as a group, are clearly not relevant to him. Thus it is a further object of this invention to provide an interface to existing search engines which speeds and simplifies a user's access to found information relevant to his needs, while helping him to dismiss or ignore found information which corresponds to his search request but is not relevant to his needs.

A further object of the present invention is to translate the search requests of a user before transmitting them to a search engine, and to translate the results of a computer search before presenting them to a user. In this, the present invention further overcomes limitations of prior art in that prior art, although it does contemplate translating documents and Internet web sites, yet it does not include tools which substantially facilitate the search process for users searching material in a foreign language.

A further object of the present invention is to provide means for specializing search engines for particular populations of users.

A further object is to provide non-intrusive methods for collection information about users. The invention constitutes an advance over prior art in that it contemplates using information gleaned from users of a computer system to tailor the output of the system to the user's needs, thereby overcoming user resistance to the collection of such information. The invention further comprises methods for collecting useful information about the user unobtrusively, without interrupting his chosen voluntary activities, and without requiring of him special activities such as answering questions.

Definitions:

“Internet”: reference is made herein to the Internet, to Internet searching, etc. The inventions described below as well as the descriptions of prior art are equally applicable to searching on intranets, extranets, and on large and small networks and on individual computer systems. Thus while our disclosure and the examples of use given herein are sometimes described in terms of Internet searching, this is to be understood to be an example of the use and utility of the inventions, and is not intended to imply any limitation in the scope of their use. To the contrary, the inventions here disclosed should be understood to be applicable as well to such systems as intranets, WANs, LANs, and to individual computer systems.

“Text”, “Site”, “URL”: the words “text” and “site” or “sites” and “URL” or “URLs” are sometimes used herein to refer to the object found by a search. It is to be understood that these words when used in this context are used by way of example, and that the found objects may be text documents, Internet sites, or any other unit of found information existing in a computer system, LAN, WAN, Extranet, Intranet or the Internet, and described or describable by words. In particular, it includes web pages, graphics objects, multimedia objects, etc.

“Preference”: The disclosure herein states in various contexts that priority or preference is give for certain selections over other selections, or for certain arrangements over other arrangements, because they have some characteristic which the user, or some group of users, has been shown to prefer or can reasonably be assumed to prefer. This concept of user preference should be taken to include also the opposite phenomenon, namely negative preference (low priority, exclusion) given to certain selections or arrangements because they have some characteristic which the user or group of users has been show not to prefer, or could reasonably be assumed not to prefer. Since it would be tedious to repeat both the positive and the negative side of this “preference” in every context, we here state that when the positive preference is referred to in the following, the possibility of the use of “negative preference” (low priority, exclusion) should be understood to be meant as well.

“Similar”: in the following disclosure, when two users are said to be “similar”, this means that there exists a positive correlation among data elements associated with the two users, from at least some subset of the data associated with the two users within the system. When a group of users is said to be similar to a given user, this means that there exists a subset of the set of all users of the system, each member of the subset is similar to the user, over at least some subset of the data know to the system about the users.

“Display”: the word “display”, used herein to describe the process of making visible, to one or more users, the results of some process of computer searching or computer analysis. The word “display” should be understood to include not only such traditional forms of display as showing the results on a computer monitor such as a CRT monitor or LCD monitor, but also any other method or mechanism of making the results so visible, including processes of printing the results, and processes by which the results are transmitted to systems capable of making them visible to users, either immediately or subsequently.

### BRIEF DESCRIPTION OF THE DRAWINGS

The invention is herein described, by way of example only, with reference to the accompanying drawings. The drawings are provided so as to show the general structure of preferred embodiments of the invention. Details in the drawings are illustrative only, provided by way of example, and the invention taught herein is not limited to those specific details or specific implementations. Rather, the details presented are intended to assist in the general understanding of the principles involved, and are not to be understood as limiting the invention. No attempt is made to show more detail than is necessary for achieving a fundamental understanding of the invention, which clearly may be implemented in a variety of forms and manners.

In the drawings:

FIG. 1 is method for displaying prioritized results of a computer search, according to the present invention;

FIG. 2 is a system for displaying prioritized results of a computer search, according to the present invention;

FIG. 3 is a method for choosing search engines for executing a computer search, according to the present invention;

FIG. 4 is a method for analyzing and displaying the results of a computer search, according to the present invention;

FIG. 5 is an example of output generated by an embodiment of the present invention;

FIG. 6 is a further example of output generated by an embodiment of the present invention;

FIG. 7 is a further example of output generated by an embodiment of the present invention;

FIG. 8 is a further example of output generated by an embodiment of the present invention;

FIG. 9 is a method for facilitating computer searching in foreign languages, according to the present invention;

FIG. 10 is a method for selecting among alternative possible translations of words, according to the present invention.

### DETAILED DESCRIPTION OF THE INVENTION

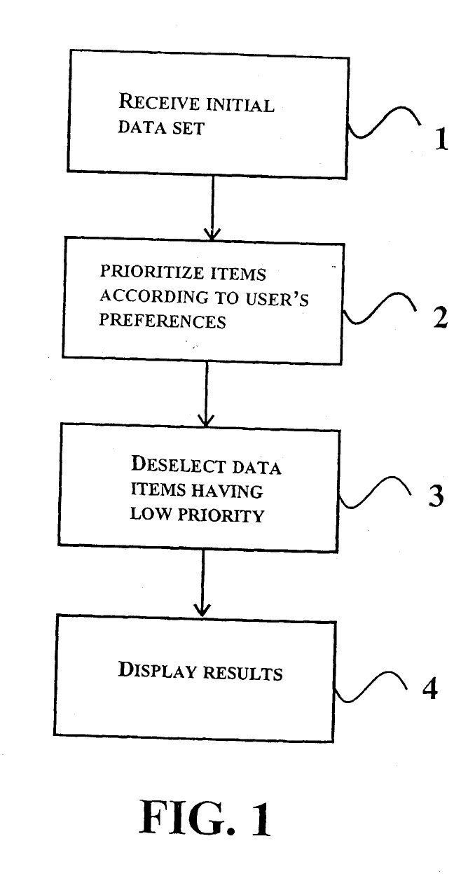

FIG. 1 describes the procedural steps of a method for enhancing the output of computer search process or other item selection process. In a preferred embodiment, at step 1 the system receives a data set, a collection of items from a data set source. A data set source will typically be a standard search engine, to which a user has supplied a query. At 2, the system prioritizes the items according to information know to it about the user's preferences. At optional step 3, the system may eliminate from the data set items with a low priority, i.e. items which seem unlikely to be of interest to the user according to the calculations of step 2. In step 4, items of the data set are displayed on a display device or printed on a printing device. In a preferred embodiment, step 4 includes displaying the results in a manner which gives expression to the prioritized ranking of the items according to the results of step 2.

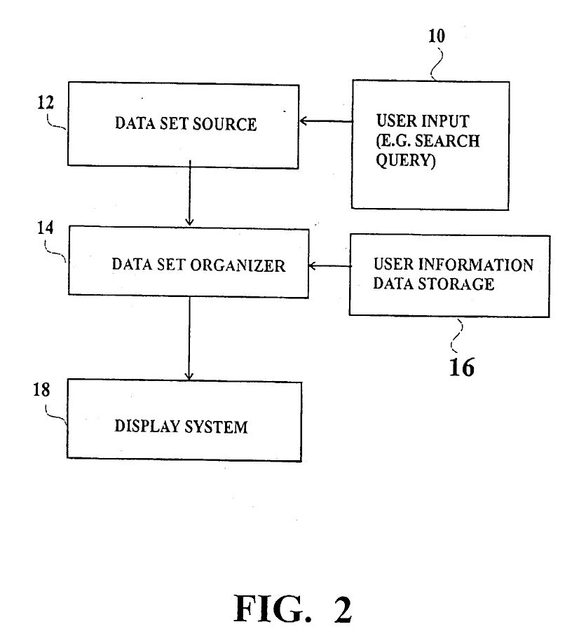

FIG. 2 presents a computer system for implementing the method described in FIG. 1. User input 10 is provided by a user to a data set source 12, such as an Internet search engine. Data set source 12 provides (through computer searching or by some other means) a data set, and passes the data set to data set organizer 14. Data set organizer 14 refers to characteristics of items in the data set, and also to stored information about the user, or stored information about other users similar to the user, from user information data storage 16, and calculates priority scores for the items in the data set. Data set organizer 14 may also eliminate items from the data set because of low priority scores. The prioritized items are then passed to display system 18, which then displays them so that they can be seen by a user. In a preferred embodiment, the method of display gives expression to the relative priority scores of the various items.

Thus, according to this embodiment, information stored on a computer system about the searcher is used to influence the prioritization of the sites presented to the user on a display. Optionally, low priority sites may be eliminated from the display.

The subset of found sites reported to the user is may be ordered, and may be selected, according to one or both of the following methods:

Priority is given to items having characteristics known to characterize items suitable to a particular user.

Priority is given to items having characteristics known to characterize items suitable to users who are similar to a particular user.

Measures of similarity which might be relevant to users viewing Internet sites, for example, might include: similarity in demographic information (for example geographical area, age, profession), similarity in opinions expressed when evaluating Internet sites or other items (for example in evaluating sites found by searches), and similarity in behavior or performance while using the site or while using software downloaded from the site (for example similarity in the speed with which users respond to particular stimuli presented by the site).

Note that characteristics of the sites may be indicated by the sites themselves (e.g. in meta-tags), or deduced about the site from some known characteristics generally found to characterize sites consistently (e.g. site pages referring to themselves as “home” pages and including hyperlinks referring to offers of employment are generally owned by commercial entities). Yet the characteristics of the site relevant to its appropriateness for selection need not be limited to those which can be characterized a priori; it is sufficient to have observed a statistical correlation between any measurable characteristic of a site and any of the expressions of opinion or preference mentioned above. That is, if dentists prefer sites about boating to sites about fishing when sending queries about vacations, that information is useful and can be applied to the selection of search results to be presented to the user, regardless of whether the designers of the search engine have any hypotheses as to why this is the case. Indeed, correlations of this sort may be made automatically, and their results used in the preparation of search reports, without any human intervention nor any attempt at theoretical interpretation. The search engine using this method can give people what they want without “knowing how” it is doing so.

In another embodiment of the invention, information known to the system about a particular user is used to influence the method of performing the Internet search. Information about the user and his preferences, or information about users known to be similar to the particular user in some respect, and their preferences, may be used to influence or control the execution of the search itself, in a manner similar to that described above for controlling the prioritizing of sites found by the search.

It is well known, for example, that some search engines and/or web indexes specialize in particular fields of knowledge and endeavor. Consequently it is desirable that a meta-search engine (an engine which sends a search request to several independent search engines and presents to the user the combined results) interpret the search request sufficiently to determine which particular search engines are most likely to provide good information for the given subject, and re-direct the users query to such sites.

Our invention goes beyond this basic idea, however, and contemplates modifying the choice of search engines according to the personal characteristics and known preferences of the particular user, and/or of a set of users similar to the particular user. Thus whereas the engine might recognize that a particular query is concerned with matters of health, it might direct the search to one set of sources of information if the query comes from a mother and housewife, and quite another set of sources of information if the query comes from a medical specialist.

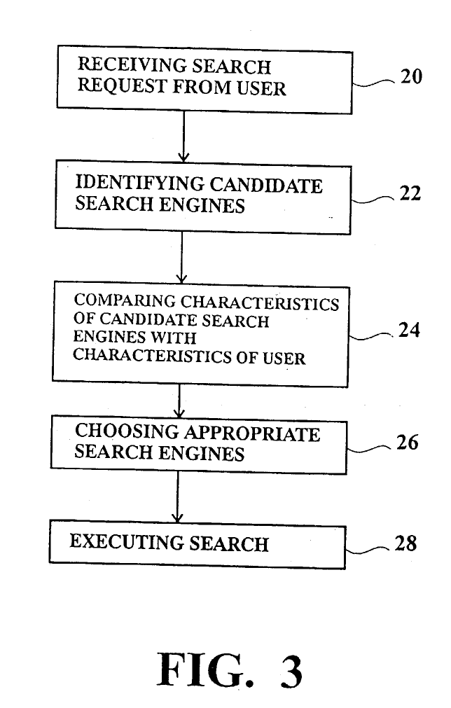

FIG. 3 presents the steps of a method according to a preferred embodiment of the invention. Step 20 is the receiving of a search request from a user. Step 22 involves identifying candidate search engines, those known to have access to indexes that include information relevant to the searched objects. At step 24 the characteristics of the candidate search engines are compared to a set of characteristics of search engines deemed desirable for a particular user. At step 26, at least one search engine is selected from among the candidate search engines according to the calculations of step 24, and at step 28, the search is executed using the selected search engine or search engines.

Here, as above, the functional correlations which control the behavior of the search engine may be linked directly to opinions expressed by the user. For example, he may consistently approve of one kind of site, or tend to use information that comes from one kind of site, and consistently tend to ignore pointers to sites of another kind. Alternatively, they may be linked to the user indirectly, through the correlations between this user and other users with whom he is similar in some respect. For example, we might not know what kind of site he likes when asking about cars, yet know what kind of site he likes when asking about sports; if we also know what kind of sites about cars are preferred by other users who share his taste in sites about sports, we can use that information to choose what to present to this user.

An additional embodiment of the present invention involves the presenting of the results of a computer search in hierarchical format, where the hierarchy of texts is constructed from the results of a particular search executed by a particular user, and is not the result of a hierarchical structure which was determined in advance of the particular search.

The hierarchy is constructed in such a manner that the material found is divided into major categories, each major category may be divided into several subcategories, each subcategory may be further divided into sub-sub-categories, and so on. The level of detail that can be achieved depends only on the desires of the user and the amount of material available to be presented.

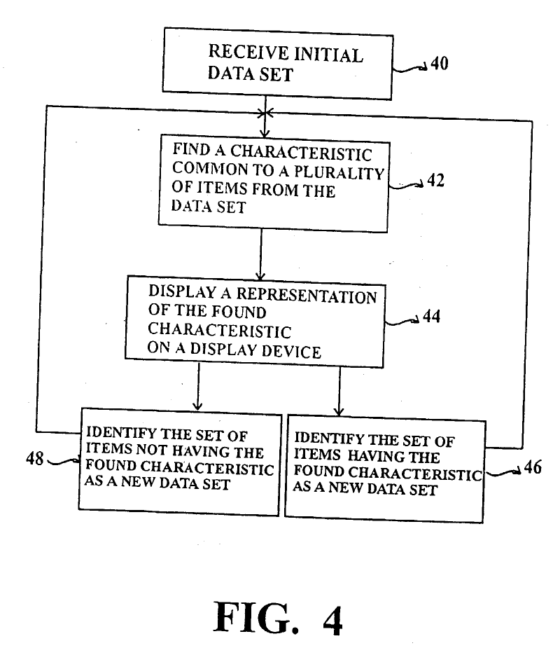

FIG. 4 presents a method for accomplishing this, according to the present invention. At step 40, a first input data set of items is established. In a preferred embodiment, this first input data set of items will be a set of items supplied by a search engine in response to a user's search request, yet alternatively the first input data set of items may be any set of items characterized by keywords or descriptions of any sort, or capable of being so characterized, and may be items received from one search engine, from a plurality of search engines, or from any other source.

At step 42, a characteristic common to a plurality of items from among the items of the input data set is found. In a preferred embodiment, where the data set is a set of results provided by a search engine in response to a search request, the analysis is performed by treating the descriptions of the found items provided by the search engine (e.g. the text accompanying each URL in a typical Internet search engine results list) as keywords or descriptors of the found objects, and analyzing them statistically to identify keywords or descriptors common to a relatively large sets of items. Other techniques of analysis may be applied, so long as the result is to identify a characteristic common to a plurality of items from among the items of the data set.

A defining characteristic having been chosen, the set of the items of the input data set that have the characteristic in common is called the “selected” set, and the input data set from which it was selected is called the selected set's “including” set. The set of the items consisting of all items of the including set exclusive of the items belong to the selected set is called the “unselected” set. (This set consists of the items of the input data set that do not have the designated characteristic common to the items of the selected set.) The unselected set has the same “including set” as does the selected set.

At step 44, the name of the characteristic common to the selected set, or some graphical or other representation of that characteristic, is displayed on a display device.

At optional step 46, the selected set is taken to be a new input data set, and the process is set to repeat from step 42, where a new characteristic common to a new selected set is identified. In a preferred embodiment, under such repetition, each time the process arrives at step 44, the name or representation of the characteristic common to the new selected set is displayed in a manner which shows it to be associated with, and possibly subordinate to, the name or representation of the characteristic of the selected set's including set. Note that both a selected set and an unselected set are wholly contained subsets of their including sets.

At optional step 48, the unselected set may also be treated as a new input data set, and the process may be further continued by repeating from step 42. Increasingly detailed analyses of selected and of unselected sets may be repeatedly undertake to any desired degree of detail, or until the sets in question cannot be further subdivided in the manner described.

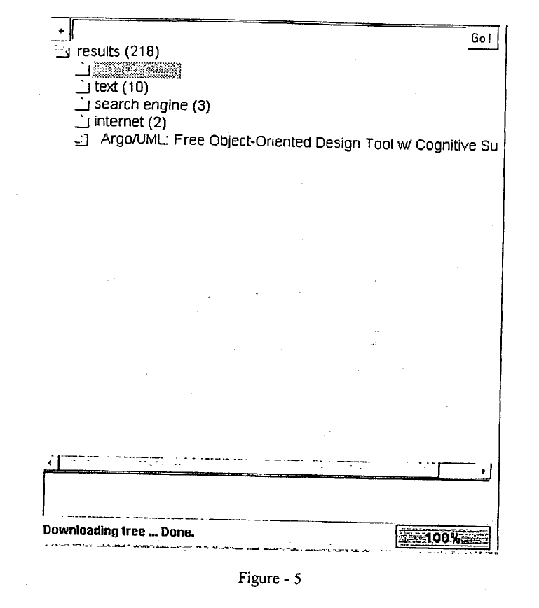

FIGS. 5-8 are examples of the output from such a process, according to a preferred embodiment. The examples were generated by passing a search request (“London”) to an Internet search engine (www.Google.com), receiving Google's standard output (in this case 218 found URLs), treating the text accompanying the URL designation in Google's output as a set of descriptors for each URL, ignoring common words (“and”, “the”, etc.), and then subjecting the resulting data set to the method of analysis and display described in FIG. 4.

FIG. 5 shows a first set of results. Application of step 40, step 42, and step 44 to the initial data set produced the word “London”: 202 URLs were found to have the word “London” as part of their descriptions, hence were selected into the selected set at that point. Application of step 48 to the unselected set (the set of URLs which did not include the word “London”) produced the word “texts”, found in the descriptions of 10 of the remaining URLs. An additional application of step 48 to the remaining unselected set determined that three of the remaining URL descriptions included the word pair “search engine”, two had the word “internet” in common, and one URL was found to have no characteristics in common with any of the previously selected URLs.

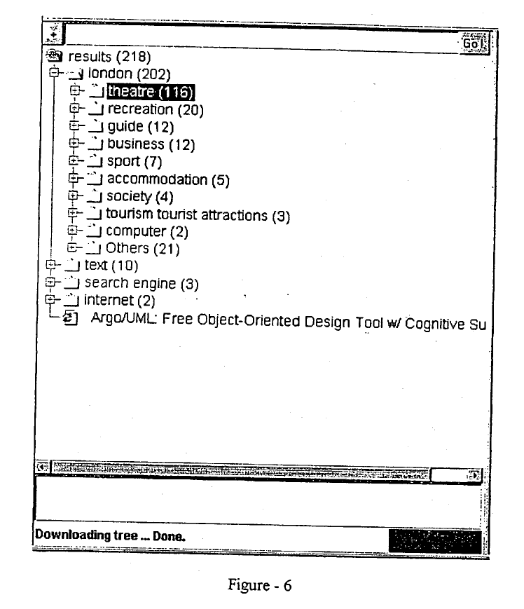

FIG. 6 shows the result of further application of steps 46 and 48 to the data set. Application of step 46 to the first selected set (the set selected by the presence of the word “London”), caused the selection of a set characterized by the word “theatre”. 116 URLs, of those with the word “London” common to their descriptions, also had the common word “theatre”. At that point, repeated application of step 48 to the unselected sets at that point produced the list of words following “theatre” in the figure. For example, from within the set selected by the word “London” but unselected by the word theatre, 20 were selected by the word “recreation”. Of those selected by “London” but unselected by “theatre” and further unselected by “recreation”, 12 were selected by the word “guide”. Further application of the same principles produced the further characterizations “business”, “sport”, and so on.

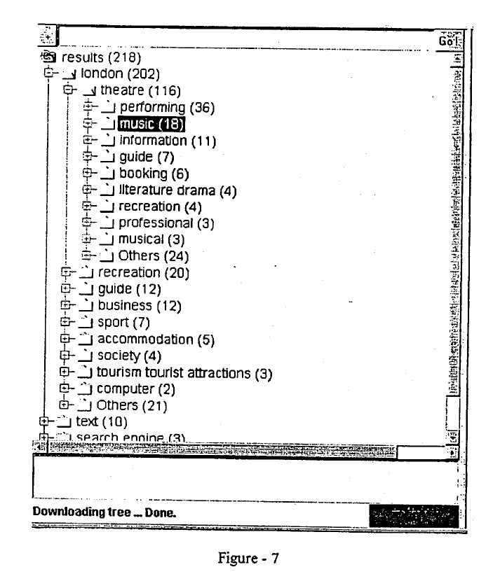

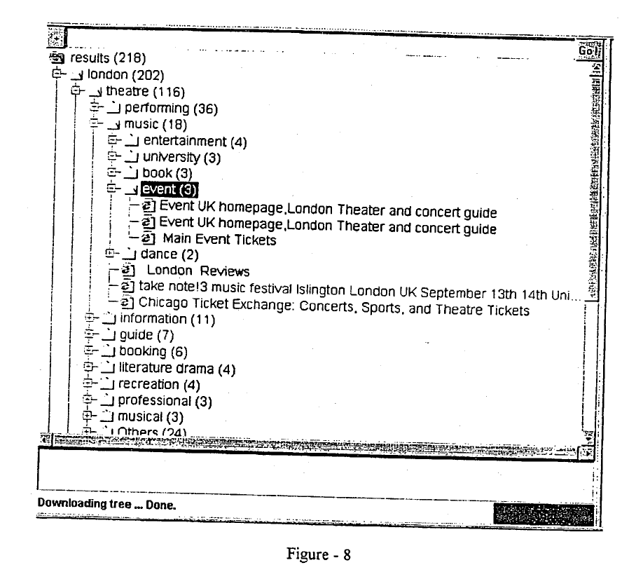

FIGS. 7 and 8 represent the result of continuing the process described herein, on the same data set, to increasing levels of detail.

In the preferred embodiment here described, the display was organized by placing words describing selected sets below and to the right of words describing those selected set's including sets. Unselected sets having a common including set are listed one under another at the same level of indentation. Thus, “theatre”, “recreation”, “guide”, etc., are listed at a same level of indentation, under “London”.

It should be understood that the examples given in the figures are provided as an aid to understanding the general principles of the invention, and should not be taken as limiting the invention in any way. Selection of the characteristics may be made in a variety of ways. Selected sets selected from identical including sets may be mutually exclusive or overlapping, for example. Selection criteria may be chosen as a function of the size of the selected set they produce, or according to a variety of other criteria.

It may be noted that one advantage of the method herein described is that the choice of major and minor categories displayed to the user is determined uniquely by the particular set of results presented to the display module by the external search engine. The process does not need to refer, nor does it refer, to any prior knowledge about the subject not to any particular structure or relationship of subjects or categories know or determined in advance of the search.

In a preferred embodiment, a software implementation of the method of FIG. 4, demonstrated by example in FIGS. 5-8, is a client-server system in which the user interacts with the client software and makes a search request. That request is sent to the server system which sends it out to a selected group of Internet search engines, receives the results supplied by those engines, and extracts from them the textual material describing the set of sites (URLs) found by those engines. It then organizes that information ‘on the fly’ into a hierarchical information structure. It does this by analyzing the textual material to find the most important common subjects existing among the found data, and identifying them as major categories. It then repeats the process recursively on each identified major category to produce further sub-categories and sub-sub-categories, to any desired level of detail.

The server software then sends an initial view of that logical structure back to the client application. FIG. 5 shows an example of the display provided by the client software at that point. FIGS. 6 through 8 further demonstrate the fact that the process by which iterations of the loop described in FIG. 4, where either step 46 or step 48 leads to a reiteration of step 42 in a recursive process, may be influenced or controlled by a user in an ongoing interaction. According to this process, a user, responding to a display, clicks on categories of information that interest him, thereby commanding further iterations of the process described by FIG. 4, and thereby “drills down” into the hierarchy, getting at each stage increasingly detailed divisions and subdivisions of the chosen subject, according to the methods presented herein.

However, the determination and construction of this hierarchy may be done automatically, based on available information about the found sites, and requires no human intervention. The hierarchy is not fixed in advance—the hierarchy reflects the intrinsic organization of the particular data set of items to be presented. Thus for example in one search “cars” might be a subset of “racing”, and in another search “racing” might be a subset of “cars”—the choice would depend on what particular set of internet sites was found, and that would depend in turn on the particular search request, and perhaps depend as well (as hereinabove) on characteristics of the particular user as well.

There are two major advantages of this method of displaying search results over the traditional method of presenting a list of sites found.

First, this method presents a “birds' eye” view of the found information. That is, the hierarchy, derived from the set of found items, teaches the user something about the nature and ‘landscape’ of the information uncovered by his query. In other words, the hierarchy itself constitutes a form of information.

Second, this method of displaying the results provides an excellent tool for discarding or ignoring irrelevant sites. It may not be easy, and is sometimes not even possible for a user to specify exactly what he wants, but it usually is quite easy for him to recognize (once presented with a display such as that of FIG. 5) what he does not want. Given a display of the sort shown in FIGS. 5-8, the user easily concentrates his attention on categories that attract him, and never needs to look at any detailed information about sites from categories that clearly do not interest him.

In a further preferred embodiment of the present invention, step 42 of FIG. 4 (the process of choosing and of naming the characteristics which form the basis for selected the selected sets) is influenced by the user's tastes and preferences, or by the tastes and preferences of a group of users know to be similar to the him in some respect.

Users' tastes and preferences may have been expressed explicitly, or implicitly. An example of an explicitly expressed preference is that a user requests that e.g. nouns appearing in the descriptions of items be used as defining characteristics, but adjectives not be so used. An additional example is that a user asks that certain tests be applied to items of the data set and the results used as defining characteristics, for example by requesting that the display of Internet search results distinguish between commercial sites and non-commercial sites. Examples of implicitly expressed tastes and preferences include situations where the user, without making any general statement about his preferences, asks the system to hide or ignore defining characteristics, and the characteristics he chooses to be hidden and ignored are frequently adjectives and never nouns, or similarly, where a given user frequently and typically investigates found Internet sites whose URLs end in “.com”, and never visits sites whose descriptions include the word “my”, as in “here's what I did with my vacation”, or “here is a picture of my favorite car”).

With respect to user preferences controlling the construction of a hierarchy, the situation is similar to those we've seen above with respect to the choice of search engines and the choice of found sites to be presented to the user. Here, as there, the preferences which control or influence the choice of categories may be those of the user himself, or those of a sub-set of the set of users of the system, which subset has expressed opinions or engaged in behaviors which correlate positively with the particular user's opinions and behaviors. Alternatively, the sub-set of users whose preferences control the process might be a sub-set to which the particular user belongs by virtue of similarity of demographic details of one sort or another. One might use such things as, for example,

geographical location, or

subjects of previous searches, or

responses to URLs provided by the system as a result of previous searches, or combination of such types of information.

Examples of areas in which the expressed or implied preferences of the particular user, or of users similar to the particular user, can be used with good effect in influencing or controlling the selection of major and minor categories for organization and display of the search results include

types of words chosen as categories

parts of speech chosen

long words vs. short words

technical terms vs. popular expressions

business terms vs. non-business terms

role of the words chosen as categories

priority given to meta-tags

priority given to repeated words

priority given to titles

particular words, or types of words, chosen to be ignored as categories

preference for multiple small categories vs. a few large categories

preference for exclusive categories vs. inclusive categories

Of course the preceding list is not intended to be exclusive, but rather merely indicative of the sort of choices which may be facilitated by paying attention to statistical similarities among users, and using that information to influence the choice of material to be presented in internet searches, and the manner of its presentation.

The overall effect of the use of the techniques described above is to provide a search engine capable of adapting itself to particular users, and able to do so painlessly and automatically. The search process, the choice of found sites to display, and the method of presentation of that display, all can be molded to the particular user. His opinions and behaviors can be matched with the opinions and behaviors of other users to identify those who are similar to him in certain respects, and then their opinions and behaviors can be used to further modify the search experience in ways likely to suit the particular user's needs. Furthermore, the presentation of the results of the Internet search in the form of a spontaneously generated hierarchical structure not dependant on previous human organization in itself constitutes a major facilitation of the search process, whether or not the hierarchy is influenced by being adapted to the specific user's tastes, opinions, and behaviors, and to those of users similar to him.

An additional embodiment, in which search results can be further enhanced using information about user preferences and user characteristics known to the system, is for the search results to be translated before being presented to the user.

As previously shown, there is need for a search system that allows users to conduct their search in their own language, yet find sites in other languages.

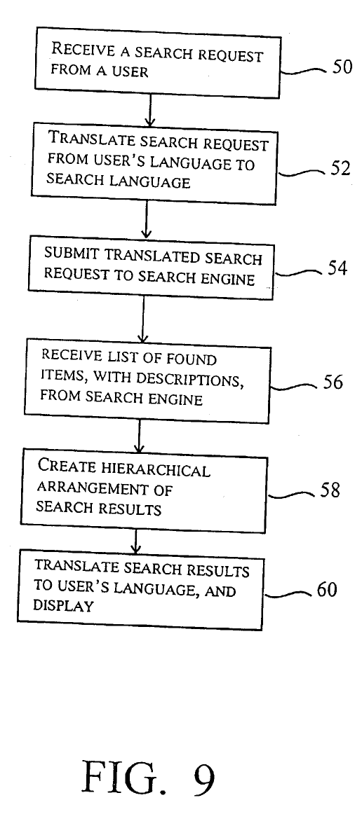

FIG. 9 presents a method for accomplishing this purpose. This embodiment further adapts the search process to the need of an individual searcher by optionally translating his search request into a target language, and by translating into his language the display of search results.

Translation of the search request is relatively trivial; since many search requests are a single word, or a short list of words related by Boolean (rather than natural language) syntax, machine translation of most search requests would not create major problems.

Search engines generally respond to a search request by presenting the users with a summary (usually in the form of an annotated list) of what was found, allowing the users to select elements from the list for closer inspection. If the summary is in a language convenient to them, users can more easily peruse the body of found information and choose items that seem to justify the effort to read them in the original language.

Automatic machine translation is not yet highly perfected, but for the purpose described here, the levels of automatic translation available in current commercialized software packages is likely to be sufficient. Since search engine summary texts are generally based on keywords from the found sites themselves and/or quotes (sometimes fairly arbitrary) from the text of the found site, the ‘literary’ level of the texts presented (elegance of the language, consistency, even completeness of sentences) is usually not high, consequently the demands on a translation system to produce elegant, consistent, and complete output is correspondingly reduced.

FIG. 9 presents a method for facilitating searching for a user wishing to search material in a language not his own. The method involves the following steps. At optional step 50, a search request is received from a user who makes his request in his native language. At optional step 52 that request is translated into the language or languages of the material he desires to search. At step 54 his search request, in the language of the material to be searched, is submitted to processing by one or more search engines. At step 56, a list of found items is received from the search engine(s). In optional step 58, a hierarchical arrangement of the search results may be prepared, according to the principles described herein and in particular in connection with the discussion of FIG. 4. In step 60, the search results (whether transformed into a hierarchy by step 58 or in their original form) are translated into the user's language, and displayed to him.

In the case of the hierarchical display of search results discussed in the context of FIG. 4, the translation problem is simpler than it would be in translating the results list is generated by the search engine. As seen in FIGS. 5-8 and discussed above, the hierarchical display created through the use of the methods described by FIG. 4 can be produced in the form of a hierarchical “tree” of results, a hierarchical structure in which “branches” (category names) are typically labeled by a single word (the name of the category), or by several words which happen to all characterize a group of items but which have no necessary syntactical relationship (e.g. “modem connect baud”), or by a short phrase of words typically found together (e.g. “baud rate,” “life insurance”). Thus it is possible to translate search output from one language to another with relative ease, once such a hierarchical ‘tree’ arrangement of the output information has been created. Translation is facilitated by the fact that most categories (i.e. most defining characteristics) can be expressed as single words, and no long sentences or complex linguistic syntax is typically involved.

In less usual cases a given word might be translatable into several possible alternatives in the target language. For example, the English “bank” might be rendered in French as “banque” (to save money in) or “rive” (riverbank). In such a case one might simply present the most popular choice, or several choices, since the user, knowing what he was searching for, will understand the words presented. However, a preferred solution uses the fact that each of the possible target words will, in any representative body of examples of its use in the language, be associated with a variety of other words with which it often appears together. (“Bank” meaning “banque” will often appear with words like “check”, “credit”, or “interest”, while “bank” meaning “rive” will often appear with words like “river”, “stream”, or perhaps “fishing”.). In the construction of our tree, at any particular point in the tree, a word or words will have been identified as being the best description of an associated group of texts at that point. In translating that word or words, if several alternatives appear possible, it is a simple matter to compose a list of other words associated with the group of texts belonging to the category at that point of the hierarchy, and to compare those words to lists of words associated with each of the translation word candidates. The presence of words often associated with one candidate, and the absence of words often associated the other candidate(s), will likely make it possible to select the correct translation.

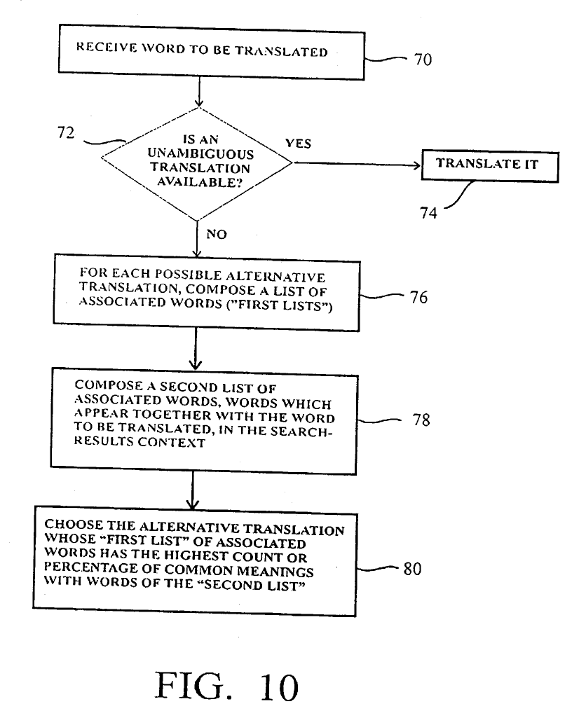

FIG. 10 presents this method in further detail. At step 70 the system receives a word to be translated. At 72, a dictionary lookup is performed to see if there exists more than one possible translation of the word. If not, then if any translation exists, the word is translated at step 74. If more than one candidate translation exists, then at step 76, a “first list” of words frequently associated with each of the candidate translations is identified. (This process, of course, may be done in advance for all the words of the dictionary). At step 78, the context in which the word to be translated appears is inspected, to create a “second list” of words appearing with it in the current context. (In the preferred embodiment, where this method is used to translate the hierarchical analysis of a set of search results, the second list might optionally include the words appearing near the word to be translated in all of the places where the word to be translated appears within the initial input data set, or in near the occurrences of the word to translated within the selected set, as described above.) In step 80, a comparison is made between the meanings of the words found in step 78, and the meanings of the words found to be associated with each of the candidate translation words in step 76. In most cases, one and only one of the candidate translations will be found to be associated with a set of words whose meanings have much in common with the meanings of the words found in step 78.

(Reference is made to comparing meanings of the words, rather than comparing the words themselves, since words of the first list will be in a first language, and words of the second list will be in a second language. One method of implementing the comparison is to translate all the words of one of the lists (or all the words for which an unambiguous translation is known) into the language of the other list, and then simply comparing the translated words of the one list to the words of the other list. This might be done in either direction (i.e. translating the first list, or translating the second list), or even in both directions.

Of course, in unusual cases it may turn out that the group of found texts, at some point in the hierarchy, actually contained texts grouped into two or more different subjects and properly translatable by two or more different words in the foreign language. The same list comparison describe above would show this fact, and then these texts could be regrouped separately in the tree, each with its different translated word.

The method of selecting an appropriate translation when translating words which might be translated in several possible ways has been presented herein primarily in the context of the example of translating computer search results. However it will be clear to a reader skilled in the art that the method here presented, and particularly with reference to FIG. 10, may in fact be usefully implemented in a wide variety of contexts. The example of the use of the method in the context of translating computer search results is here provided by way of example, and is not intended to limit the invention herein described, but merely to illustrate its usefulness in a particular context.

Previously described embodiments showed ways in which a general-purpose search engine can adopt its responses to the known tastes, desires, and other personal characteristics of each particular user. An additional embodiment takes this process a step further, by designing a search engines to fit the needs of specific populations or situations.

Let us consider, by way of example, a search engine specialized for the needs of children.

Such a search engine might have some or all of the following characteristics:

Limitation of found material: material considered not appropriate for children would simply not appear among the output of the search engine. This is to be contrasted with the current state of the art, in which software intended to prevent children's exposure to objectionable material will usually prevent the child from loading a URL containing objectionable material, but will not prevent references to such sites from appearing in response to search requests. (In some cases, if sufficient ‘offensive’ material is presented in the sites' descriptions as they appear in the search output, then all the search output, (offensive and inoffensive) may be prevented from display by the same protective software.)

Thus, there would be considerable advantage to a search engine which avoids both the alternatives above, and conducts searches which do not find and do not refer to objectionable material, without blocking access to non-objectionable material.

The search engine designed for children contemplated in this embodiment would move the selection of acceptable vs. objectionable material into the search process itself. That is, either the search would be based on an index of sites pre-filtered to eliminate objectionable material from the entire index, or else at the time of the search, the search engine having identified the searcher as a child, would filter the results of the search and present only appropriate found information to the searcher. Thus, to take a well-known example, a school child could search for “Little Women” and not risk finding a list of porno sites.

As stated, the idea of a children's search engine was given by way of example, and the invention contemplated is not limited to that example. The general idea is to classify information according to its appropriateness to the target population, and to supply only that which is appropriate in response to a search request. A sixteen-year-old searching for “gyroscope” might be happy to find an article from, say, the Encyclopedia Britannica, yet a 10 year old would not.

Translation and interpretation of the search request: Adult users frequently develop a certain amount of sophistication in the manner in which they enter search requests, but children cannot be expected to start their Internet careers with adult sophistication. In particular, we note that the way children typically express certain ideas is quite different from the way they would be expressed by an adult, yet the meaning is unambiguous in context. It is possible to develop a system in which “translates” the child's search request input into language appropriate for Internet searching. (As a simple example, take the phrase “the war of independence”. Depending on where the child is, that phrase could refer to quite a variety of different wars. The same principle (that of resolving ambiguous requests in favor of meanings likely to be intended by the specific population) could eventual resolve even such requests as “tomorrow's weather” and “the score of the big game”.

We may note in this context that such translation or reinterpretation of a naïve search request need not be wholly automatic. To serve the purpose it would suffice to present the child with a variety of likely alternatives, explained in language understandable to him, and ask him to choose. Thus a search on “Washington” might be answered with a request to choose between “George Washington, first president of the United States”, “Washington D.C., capitol of the U.S.A.”, “the state of Washington, on the Pacific ocean between Oregon and Canada border, and famous for salmon and software . . . ” or whatever.

Appropriate organization of the search results: Earlier sections of this document dealt with processes for organizing the output of Internet searches to make that output easier for searchers to understand and to use. We note here that a search system dedicated to a particular population can use that fact to organize search output in a manner appropriate for the population. In a search engine made for children, for example, the process of construction of our ‘tree’ output can give preference to categories likely to be understood by children. In addition to using simpler words and common concepts more likely to be familiar to children, it is possible to use general categories to replace, or explain, specific and specialized categories. Thus a child searching for CDs would find it useful to be told that in addition to finds about discs with digital recordings of music or software, he had also found “certificates of deposit”, and that those had something to do with money and investments.

Prioritization of results according to probable interest: A further way in which a search engine might specialize in a particular population, such as young searchers, would be to prioritize results in terms of found objects know to be of interest to such users.

The principles here listed as being appropriate in the example case of a search engine specialized for children, can in fact be generalized to the idea of search engines specialized for any particular target population with common characteristics. For example, there exists a population of adult users who are different from children in that they are indeed adults, but somewhat similar to children in that they are (self-declared) unsophisticated in the ways of the Internet, electronic searching, and hi-tech in general. Such users could similarly benefit from a search engine which translated naïve searches into language more likely to find the required information, then translated the search results back into categories likely to be understood, accompanied by explanations, or hints for how to search further in the particular subjects, etc. At the opposite extreme, hi-tech users are relatively unlikely to be interested in home pages created by the world's high school student population, and doctors searching for information about the known characteristics of pharmaceutical products would be unlikely to want to read anecdotes from patients comparing notes in a newsgroup context. In the context of a previous embodiment we showed how a general-purpose search engine could tailor its output to a particular population or group. In current embodiment the searching process itself, and indeed the indexing process on which the search results are based, are more finely honed than would otherwise be possible, because the search engine is specialized with the needs of a particular population in mind. Limiting the found information, translating search requests from that population's idiosyncratic language into terms common in the Internet, then translating the found information (or at least categories of found information) back into terms likely to be meaningful to the target population, would be useful in many contexts. This would allow not only for the search engine (and the engine's indexing software) to specialize in particular subjects, it would further allow filtering of input and output based on information relating to the probable subject areas being considered and the vocabulary likely to be understood. Thus, anglers searching for “flies” don't need to see URLs about great outfielders, and investors (qua investors) looking for CDs should not need to wade through information about compact disks. As for the building of ‘tree’ categories, a search engine with prior knowledge about the vocabularies appropriate to particular fields of endeavor could use this knowledge to influence the grouping of information in categories: our investor, for example, will find it convenient to find CDs and “certificates of deposit” listed together, rather than separately.

One particular case deserves mention mentioned, since it differs slightly from the examples given above. The purchaser of the software and the user of the software may not have identical interests. It may be useful to specialize search software according to the needs of, say, an educational context or a corporate context, and have the engines behavior reflect the priorities of the purchaser of the software, which are not necessarily identical to that of the users. A “commercial” search engine, for example, might be considered useful in the corporate environment if it limited the found information to that considered relevant, by the corporation, to furthering the corporation's goals. Thus a given corporation might favor a search engine which did not find information about sex or sports, considering that these are subjects better pursued by the corporation's employees on their own time.

Another embodiment of this invention is concerned with methods for collecting information about users, on which the response of the search engine to a search request may be based. As described above in the discussion of the background of the invention, information about users, their areas of interest, preferences, tastes, and behaviors, is used in various embodiments described herein, and can be of great commercial value in various other ways, yet many users have a great reluctance to providing such information to commercial internet sites, and to allowing such information to be collected about them. The current embodiment of our invention involves several improvements on the methods for collecting such information commonly in use.

The first is simply to provide for the collection of cumulative information about users' needs and interests by requiring users to identify themselves to the system before searching. (The identification required is not a ‘absolute’ identification: the search engine does not in fact need to know the user's actual identity. It is sufficient for the user to identify himself with an alias, so long as he uses the same alias every time he searches.)

Of course, such a requirement will be best accepted if the user is motivated to provide such an alias, and to use it consistently. This can clearly be accomplished refusing to provide certain services unless the user so identifies himself, yet the preferred implementation is to associate the use of the alias and the sign-in process with the providing of services which the user can clearly understand could not be provided without users self-identification, that is, services whose implementation is actually based on the stored ‘personal’ information.

One such type of service has been described above, in various enhancements to the search processes and to the presentation of search results, based on individual or statistical information about the searcher. This is clearly a useful service, and one that clearly cannot be provided absent the relevant information on which to base the activity.

Another such type of service is to allow users of the search site to store found information on the search server. This can be expanded to allow for users' storing of other sorts of information. It can further be expanded by providing follow-up services relating to previous searches by the same user, for example the automatic reporting of new sites which have recently appeared on the Internet and which answer to search requests the user previously executed.

Once the user establishes an alias (that is, an identity which he repeatedly uses to sign on to the system), the system is then in a position to accumulate information about him in a ‘user profile’.

This may be done in a variety of ways. First is the traditional method, mentioned above, of simply asking the user for demographic information about himself when he first signs on, or at some later time.

A second source is to record in a database the searches conducted by the user. Here again, user's acquiescence to such an operation will best be gained by providing a service, unobtainable and unperformable otherwise, based on the information, such as the ‘updated search’ mentioned above.

A third method is to accumulate information about the user's responses to the search output. When a general search produces tens or hundreds of URLs, the users more specific interests and tastes are indicated by his choice of which of the tens or hundreds of URLs to visit.

A fourth method is somewhat more subtle: it consists of collecting information on the user based not on the information content expressed by search requests and search choices, but rather based on his behavior when responding to the system. A user responding interactively with a site provides myriad opportunities for observing his tastes and preferences, based not on what he says about himself, but on what he does.

For example, it would be reasonable to hypothesize that a user who is very rapid in his reactions to information presented in his browser will appreciate a web site which responds speedily to his actions, whereas a user who is naturally slower or more contemplative in his responses might prefer a site whose response is less speedy, but more complete. Since the user's responses to the site can be reported back to the search system (even down to such details as some statistics about the nature of his mouse movements), the system can collect such behavioral information and use it, to the user's benefit, to personalize site output for him.

At the same time, behavioral information collected in this manner can be used for other purposes. Of particular interest is the use of behavioral information to predict both the style and the content of advertising material that might be effective when presented to the specific user. Thus, given identical information about the age and interests of a potential car buyer, one might be inclined to present a deal on a sports car to user who uses his mouse to zoom rapidly and accurately around the screen, and a more sedate automobile model to one whose movements are consistently slow and careful. Note that if the previous use of the information was characterized as being “to the user's benefit”, it is not necessarily the case that the use described here is at the user's expense or to his detriment. Given, for example, a reality in which the user is using a search site and being exposed to advertising thereon, it stands to reason that most users would prefer to see ads which might actually interest them, over ads which do not.

To further amplify the idea of personalizing the site based on information gleaned from user's behavior, we point out that not only advertising but also features and activities for the user's use and pleasure may be chosen and configured in a manner which provides the user with something he is likely to want. Information overload and the multiplicity of choices are a serious problem to many users. People often miss opportunities to benefit from services they would appreciate and enjoy, because of the multiplicity of services offered and the overhead of understanding the offers and choosing among them. Consequently tailoring proposed activities to users' preferred behavioral patterns benefits both the user and the supplier of services. To re-use the previous example, whether or not we guess correctly about our two users' tastes in cars, it seems highly probable that the former would be more likely to enjoy, say, an arcade game, and the latter, if he wanted a game at all, would be more likely to enjoy one that rewards reflection and judgment.

Note that the system can collect and use the information of the user profile without necessary human intervention, and without dependence on hypotheses of the sort mentioned above (such as the hypothesis that a user with fast and sporty mouse movements is more likely to purchase a fast and sporty car). In an environment such as that contemplated here, where a particular user's behavioral reactions to a variety of stimuli can be collected and made the subject of statistical analysis, it is possible to determine useful correlations among behaviors without needing to formulate any hypotheses at all. For example, if one were to present a variety of banner ads to a particular user, and characterize those ads with respect not to their content but to their predominant colors or graphic styles, then it would be possible to determine, given a sufficiently large number of samples for a particular user, what color or graphic style of ad would be most likely to result in a ‘click’ from the user, and to use this information to choose the color and style of the ads presented to him.

1. A method for computer searching, comprising
a) receiving an initial data set from a data set source
b) prioritizing at least some items of said data set according to a degree to which characteristics deemed suitable to a particular user are present
c) displaying at least some of said prioritized items on a display by order of priority

2. The method of claim 1, additionally comprising eliminating from among said prioritized items those of low priority, prior to executing step (c).

3. The method of claim 1, where said particular user's past expressions of preference are used to determine which characteristics are deemed suitable to said particular user.

4. The method of claim 1, where past expressions of preference by other users who are similar to said particular user are used to determine which characteristics are deemed suitable to said particular user.

5. The method of claim 4, where said other users are similar to said particular user by virtue of similarity in their demographic information.

6. The method of claim 4, where said other users are similar to said particular user by virtue of similarity in their expressed opinions.

7. The method of claim 4, where said other users are similar to said particular user by virtue of similarity in their behavior while using a computer system.

8. A method for computer searching comprising choosing at least one search engine to execute the search, the choice is made by finding a best match between known characteristics of available search engines and a set of search engine characteristics deemed desirable for a particular user.

9. The method of claim 8, wherein said set of search engine characteristics deemed desirable for a particular user is determined with respect to stored responses of said particular user to past searches.

10. The method of claim 8, wherein said set of search engine characteristics deemed desirable for a particular user is determined with respect to stored responses to past searches of a group of users similar to said particular user.

11. A method of computer searching comprising
a) receiving a search request from a user;
b) identifying as candidate search engines those known to search information collections which include information relevant to the search request
c) comparing characteristics of candidate search engines to a set of characteristics of search engines deemed desirable for a particular user.
d) selecting at least one search engine from among the candidate search engines according to the calculations of step (c), and
e) executing a search using at least one selected search engine.

12. The method of claim 11, wherein said set of search engine characteristics deemed desirable for a particular user is determined with respect to stored responses of said particular user to past searches.

13. The method of claim 11, wherein said set of search engine characteristics deemed desirable for a particular user is determined with respect to stored responses to past searches by a group of users similar to said particular user.

14. A method for presenting of the results of a computer search as a hierarchy, the hierarchy is constructed solely from results of a particular search executed by a particular user.

15. A method for presenting results of a computer search as a hierarchy, the method comprising
a) receiving an initial data set comprising a plurality of items
b) identifying a characteristic common to a plurality of said items
c) displaying a representation of said common characteristic on a display.
d) repeating the process recursively with at least one new initial data set, said new dataset being selected from the group of consisting of the set of items from the original initial data set having said common characteristic, and the set of items from the original initial data set not having said common characteristic.

16. The method of claim 15, further comprising the step of displaying a plurality of said representations of common characteristics on a display in such a manner that a first representation of a first common characteristic is shown in a manner indicating an associated and subordinate relationship to a second representation of a second common characteristic whenever a selected set of items characterized by said first common characteristic is wholly a subset of a set of a selected set of items characterized by said first common characteristic.

17. The method of claim 15, wherein said step of identifying a characteristic common to a plurality of said items is further constrained to conform to a user's tastes and preferences regarding characteristics so selected.

18. The method of claim 17, wherein said tastes and preferences are expressed explicitly.

19. The method of claim 17, wherein said tastes and preferences are expressed implicitly.

20. The method of claim 15, wherein said step of identifying a characteristic common to a plurality of said items is further constrained by to conform to tastes and preferences of a group of users similar to a particular user.

21. The method of claim 20, wherein said tastes and preferences are expressed explicitly.

22. The method of claim 20, wherein said tastes and preferences are expressed implicitly.

23. The method of claim 14, wherein said hierarchy is translated before being displayed to a user.

24. The method of claim 15, wherein said step of displaying a representation of said common characteristic on a display further comprises the step of translating the terms in which said common characteristic is represented from one language to another.

25. A system for computer searching, comprising mechanisms for receiving an initial data set from a data set source, further comprising a data set organizer for prioritizing at least some items of said data set according to a degree to which characteristics deemed suitable to a particular user are present, and further comprising a display apparatus for displaying at least some of said prioritized items on said display apparatus by order of priority

26. The system of claim 25, wherein said data set organizer additionally eliminates from among said prioritized items those of low priority, and said display apparatus does not display said low priority items.

27. The system of claim 25, wherein said particular user's past expressions of preference are used to determine which characteristics are deemed suitable to said particular user.

28. The system of claim 25, wherein past expressions of preference by other users who are similar to said particular user are used to determine which characteristics are deemed suitable to said particular user.

29. The system of claim 28, wherein said other users are similar to said particular user by virtue of similarity in their demographic information.

30. The system of claim 28, wherein said other users are similar to said particular user by virtue of similarity in their expressed opinions.

31. The system of claim 28, wherein said other users are similar to said particular user by virtue of similarity in their behavior while using a computer system.

32. A system for computer searching comprising mechanisms for choosing at least one search engine to execute the search, the choice is made by finding a best match between known characteristics of available search engines and a set of search engine characteristics deemed desirable for a particular user.

33. The system of claim 32, wherein said set of search engine characteristics deemed desirable for a particular user is determined with respect to stored responses of said particular user to past searches.

34. The system of claim 32, wherein said set of search engine characteristics deemed desirable for a particular user is determined with respect to stored responses to past searches of a group of users similar to said particular user.

35. A system for computer searching comprising mechanisms for receiving a search request from a user; further comprising mechanisms for identifying as candidate search engines those search engines known to search information collections having information relevant to said search request, further comprising mechanisms for comparing characteristics of candidate search engines to a set of characteristics of search engines deemed desirable for a particular user, and further comprising mechanisms for selecting at least one search engine from among the candidate search engines.

36. The system of claim 35, wherein said set of search engine characteristics deemed desirable for a particular user is determined with respect to stored responses of said particular user to past searches.

37. The system of claim 35, wherein said set of search engine characteristics deemed desirable for a particular user is determined with respect to stored responses to past searches by a group of users similar to said particular user.

38. A system for presenting of the results of a computer search as a hierarchy, said hierarchy is constructed solely from results of a particular search executed by a particular user.

39. A system for presenting results of a computer search as a hierarchy, comprising mechanisms for receiving an initial data set comprising a plurality of items, further comprising mechanisms for identifying a characteristic common to a plurality of said items, and further comprising mechanisms for displaying a representation of said common characteristic on a display.

40. The system of claim 39, further comprising mechanisms for preparing for recursive processing of data sets by selecting for further processing only those members of an original data set which have said common characteristic.

41. The system of claim 39, further comprising mechanisms for preparing for recursive processing of data sets by selecting for further processing only those members of an original data set which do not have said common characteristic.

42. The system of claim 39, further comprising mechanisms for displaying a plurality of said representations of common characteristics on a display in such a manner that a first representation of a first common characteristic is shown in a manner indicating an associated and subordinate relationship to a second representation of a second common characteristic whenever a selected set of items characterized by said first common characteristic is wholly a subset of a set of a selected set of items characterized by said first common characteristic.

43. The system of claim 39, wherein said characteristic common to a plurality of said items conforms to a user's tastes and preferences regarding characteristics so selected.

44. The system of claim 39, wherein said characteristic common to a plurality of said items is conforms to tastes and preferences of a group of users similar to a particular user.

45. The system of claim 39, wherein said hierarchy is translated before being displayed to a user.

46. The system of claim 39, wherein said common characteristic is translated from one language to another.

47. Software for computer searching embodied on a computer-readable medium comprising mechanisms for receiving an initial data set from a data set source, further comprising a data set organizer for prioritizing at least some items of said data set according to a degree to which characteristics deemed suitable to a particular user are present, and further comprising a display apparatus for displaying at least some of said prioritized items on said display apparatus by order of priority

48. The software of claim 47, wherein said data set organizer additionally eliminates from among said prioritized items those of low priority and wherein said low priority items are not displayed on said display apparatus.

49. The software of claim 47, wherein said particular user's past expressions of preference are used to determine which characteristics are deemed suitable to said particular user.

50. The software of claim 47, wherein past expressions of preference by other users who are similar to said particular user are used to determine which characteristics are deemed suitable to said particular user.

51. The software of claim 50, wherein said other users are similar to said particular user by virtue of similarity in their demographic information.

52. The software of claim 50, wherein said other users are similar to said particular user by virtue of similarity in their expressed opinions.

53. The software of claim 50, wherein said other users are similar to said particular user by virtue of similarity in their behavior while using a computer system.

54. Software for computer searching embodied on a computer-readable medium comprising mechanisms for choosing at least one search engine to execute the search, the choice is made by finding a best match between known characteristics of available search engines and a set of search engine characteristics deemed desirable for a particular user.

55. The software of claim 54, wherein said set of search engine characteristics deemed desirable for a particular user is determined with respect to stored responses of said particular user to past searches.

56. The software of claim 54, wherein said set of search engine characteristics deemed desirable for a particular user is determined with respect to stored responses to past searches of a group of users similar to said particular user.

57. Software for computer searching embodied on a computer-readable medium comprising mechanisms for receiving a search request from a user; further comprising mechanisms for identifying as candidate search engines those search engines known to search information collections having information relevant to said search request, further comprising mechanisms for comparing characteristics of candidate search engines to a set of characteristics of search engines deemed desirable for a particular user, and further comprising mechanisms for selecting at least one search engine from among the candidate search engines.

58. The software of claim 57, wherein said set of search engine characteristics deemed desirable for a particular user is determined with respect to stored responses of said particular user to past searches.

59. The software of claim 57, wherein said set of search engine characteristics deemed desirable for a particular user is determined with respect to stored responses to past searches by a group of users similar to said particular user.

60. Software embodied on a computer-readable medium for presenting of the results of a computer search as a hierarchy, the hierarchy is constructed solely from results of a particular search executed by a particular user.

61. Software embodied on a computer-readable medium for presenting results of a computer search as a hierarchy, the software comprising mechanisms for receiving an initial data set comprising a plurality of items, further comprising mechanisms for identifying a characteristic common to a plurality of said items, further comprising mechanisms for displaying a representation of said common characteristic on a display.

62. The software of claim 61, further comprising mechanisms for recursively processing data sets by selecting for further processing only those members of an original data set which do not have said common characteristic.

63. The software of claim 61, further comprising mechanisms for recursively processing data sets by selecting for selecting for further processing only those members of an original data set which have said common characteristic.

64. The software of claim 61, further comprising mechanisms for displaying a plurality of said representations of common characteristics on a display in such a manner that a first representation of a first common characteristic is shown in a manner indicating an associated and subordinate relationship to a second representation of a second common characteristic whenever a selected set of items characterized by said first common characteristic is wholly a subset of a set of a selected set of items characterized by said first common characteristic.

65. The software of claim 61, wherein said characteristic common to a plurality of said items conforms to a user's tastes and preferences regarding characteristics so selected.

66. The software of claim 61, wherein said characteristic common to a plurality of said items is conforms to tastes and preferences of a group of users similar to a particular user.

67. The software of claim 61, wherein said hierarchy is translated before being displayed to a user.

68. The software of claim 61, wherein said common characteristic is translated from one language to another.
